(19) United States
(12) Patent Application Publication
(10) Pub. No.: US 2007/0066122 A1
(43) Pub. Date: Mar. 22, 2007

(54) Method for cleaning socket using laser

(75) Inventor: Woon-chan Shin, Chungcheongnam-do (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/521,535

(22) Filed: Sep. 15, 2006

(30) Foreign Application Priority Data
Sep. 16, 2005 (KR) 10-2005-0087014

(51) Int. Cl. H01R 4/24

(52) U.S. Cl. 439/404

(57) ABSTRACT

A method for cleaning a socket used to test semiconductor packages using laser beam is provided. The method may include irradiating laser beam onto a socket have a plurality of contact pins to remove contaminated materials on the contact pins.

### PRIORITY CLAIM

A claim of priority is made to Korean Patent Application No. 10-2005-0087014, filed on Sep. 16, 2005, in the Korean Intellectual Property Office, the disclosure of which is incorporated herein in its entirety by reference.

### BACKGROUND

1. Field

Example embodiments may relate to a method of cleaning a socket used to test electrical performance of a semiconductor package. Example embodiments may relate to a method of using laser to clean contaminated contact pins.

2. Description of the Related Art

After an integrated circuit (IC) chip is molded and assembled as a semiconductor package, the semiconductor package may undergo a process for testing electrical performance. Test equipment may be used to test the semiconductor package. The test equipment may be electrically connected to the semiconductor package using a Hi-Fix board. A plurality of test sockets may be provided on the Hi-Fix board, and the plurality of test sockets may include a plurality of contact pins. During the testing process of the semiconductor package, the contact pins may contact external terminals of the semiconductor package.

External terminals of a semiconductor package may be plated with a conductive material, for example, tin (Sn) or lead (Pb). During testing, the contact pins of the socket may repeatedly contact the external terminals of the semiconductor package. The conductive material plated on the external terminals may come off and attach onto the contact pins to thereby contaminate the contact pins. If the contact pins are contaminated, contact resistance between the contact pins and the external terminals may increase, which may decrease test accuracy.

FIG. 1 illustrates a contaminated contact pin. A contact pin 101 may be contaminated with a conductive material 111. The conductive material 111 may form on the contact pin 101 when external terminals (for example, 415 of FIG. 4) of semiconductor packages are repeatedly tested.

Referring to FIG. 1, if a contact pin 101 is contaminated, contact resistance between the contact pin 101 and an external terminal (for example, 415 of FIG. 4) during the testing of a semiconductor package (for example, 411 of FIG. 4) may increase. If the contact resistance increases, current flow between the contact pin 101 and the external terminal (for example, 415 of FIG. 4) may decrease. Accordingly, a semiconductor package (for example, 411 of FIG. 4) may be erroneously determined as defective, thereby potentially reducing the test yield of semiconductor packages (for example, 411 of FIG. 4) and the reliability of the tests.

In the conventional art, contaminated contact pins may be cleaned using an electrolysis process or by polishing a surface of the contact pins using sandpaper. However, an electrolysis process may not completely remove contaminated materials. In addition, because removing contamination with sand paper is a manual process, contaminated materials may not be completely removed, and/or plated materials, for example, Au, which belong on the contact pin may peel off. If the contact pin plated material peels off, contact resistance between a contact pin and an external terminal may increase.

### SUMMARY

Example embodiments of the present invention may provide a method for cleaning a socket, for example, a mechanical method.

In example embodiments, a method for cleaning a socket may include irradiating laser beam onto a socket including a plurality of contact pins used to test semiconductor packages to remove contaminated materials on the plurality of contact pins.

In other example embodiment of the present invention, a method of cleaning a socket may include irradiating laser beam onto a socket used to test semiconductor packages having a plurality of contact pins to remove contaminated materials on the contact pins, and simultaneously blowing air onto the contact pins while the laser beam is irradiated onto the plurality of contact pins.

In another example embodiment of the present invention, a method of cleaning a socket may include irradiating laser beam onto a socket used to test semiconductor packages having a plurality of contact pins to remove contaminated materials attached on the contact pins; and vacuuming away the contaminated materials from the plurality of contact pins.

### BRIEF DESCRIPTION OF THE DRAWINGS

Example embodiments may become more apparent with the detailed description with reference to the attached drawings in which:

FIG. 1 illustrates a contaminated contact pin used to test a semiconductor package;

FIG. 2 is a plan view of a board, for example, a Hi-Fix board, in which a plurality of sockets for testing a semiconductor package are provided according to an example embodiment;

FIG. 3 illustrates example details of the sockets illustrated in FIG. 2;

FIG. 4 illustrates example contact pins contacting external terminals of a semiconductor package;

FIG. 5 illustrates an example method of irradiating laser beams onto the socket illustrated in FIG. 2;

FIG. 6 illustrates an example shape of the laser beam illustrated in FIG. 5;

FIG. 7 illustrates an example order of irradiating laser beams onto a socket;

FIG. 8 illustrates an example method of blowing air onto contact pins and vacuuming contaminated materials when cleaning the socket;

FIG. 9 illustrates an example order of cleaning the sockets; and

FIG. 10 is a flowchart illustrating a method of cleaning a socket according to an example embodiment.

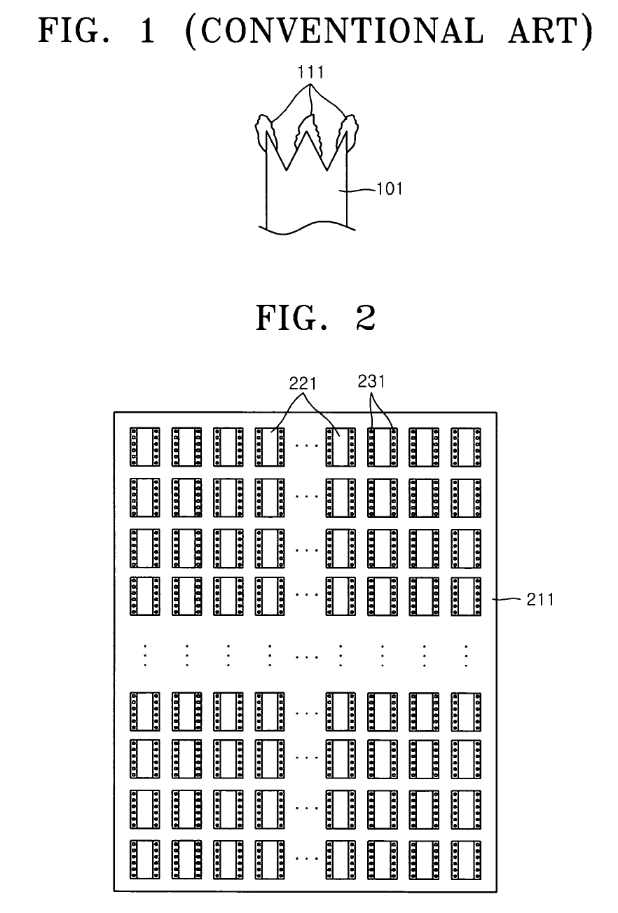

### DETAILED DESCRIPTION OF EXAMPLE EMBODIMENTS

Hereinafter, example embodiments will be described in detail with reference to the attached drawings. Like reference numerals in the drawings denote like elements.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there may be no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that may be schematic illustrations of idealized embodiments (and intermediate structures) of the present invention. As such, variations from the shapes of the illustrations as a result, for example, of manufacturing techniques and/or tolerances, are to be expected. Thus, the example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 2 is a plan view of a board, for example, a Hi-Fix board in which a plurality of sockets for testing a semiconductor package may be provided according to an example embodiment. The board, for example, the Hi-Fix board may be used to test semiconductor packages.

Referring to FIG. 2, a plurality of sockets 221, for example, 64 sockets, 128 sockets, and 256 sockets, may be provided on a Board 211, for example, Hi-Fix board 211. Each of the sockets 221 may include a plurality of contact pins 231.

A semiconductor package (for example, 411 of FIG. 4) in order to be tested may be mounted on one of the plurality of sockets 221, and external terminals (for example, 415 of FIG. 4) of the semiconductor package (for example, 411 of FIG. 4) may contact contact pins 231. The plurality of semiconductor packages (for example, 411 of FIG. 4) mounted on the board 211 (for example, Hi-Fix board) may be simultaneously tested. A parallel test method on the plurality of semiconductor packages (for example, 411 of FIG. 4) may be used.

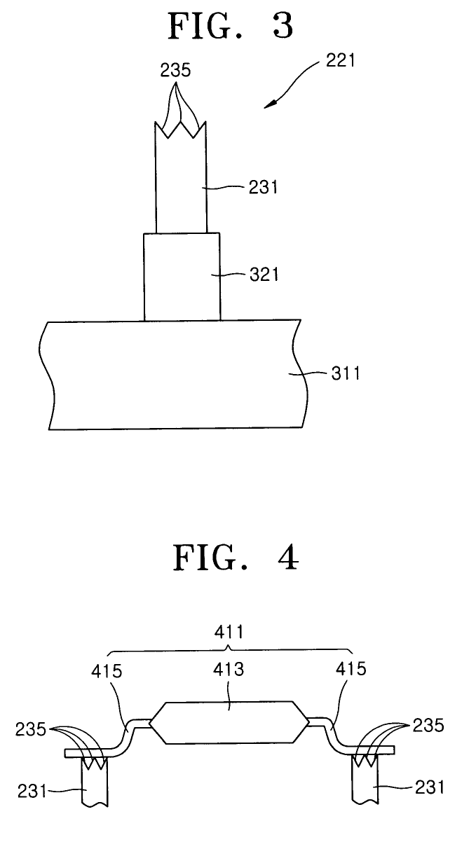

FIG. 3 illustrates example detail of the sockets 221 illustrated in FIG. 2. Referring to FIG. 3, each of the sockets 221 may include contact pins 231, a stopper 321, and a support board 311.

One end of the contact pin 231, which may include a plurality of protrusions 235, may contact the external terminal (for example, 415 of FIG. 4) of a semiconductor package (for example, 411 of FIG. 4) The protrusions 235 may decrease the contact resistance between the contact pin 231 and the external terminal (for example, 415 of FIG. 4). Thus, current consumption caused by contact resistance generated when testing the semiconductor package (for example, 411 of FIG. 4) may be reduced. The contact pin 231 may be formed of a material having higher conductivity, for example, a copper-based alloy material, for example, beryllium copper (BeCu). A surface of the contact pin 231 may be plated with a material having even higher conductivity, for example, gold. The contact pin 231 may be a pogo pin.

The stopper 321 may be connected to the contact pin 231 and may support the contact pin 231. An elastic member (not shown) may be connected to the other end of the contact pin 231. The elastic member may be provided inside the stopper 321. The contact pin 231 may move up and down by an action of the elastic member. During a test operation, the contact pin 231 may be pressed onto the semiconductor package (for example, 411 of FIG. 4) and may be electrically connected to the circuit pattern formed on the board 211 (for example, Hi-Fix board).

The support board 311 may be provided on the board 211 to prevent the stopper 321 from moving.

FIG. 4 illustrates example contacts pins contacting external terminals of a semiconductor package. Referring to FIG. 4, contact pins 231 may contact external terminals 415 of a semiconductor package 411.

The semiconductor package 411 may include a main body 413 having an integrated circuit (IC) chip (not shown), and external terminals 415, which may be connected to the IC chip, and may also transmit and receive electrical signals to and from an external system.

To test the semiconductor package 411, protrusions 235 of the contact pins 231 may be directly contacted with the external terminals 415. When the test operation is repeatedly performed, a plated material of the external terminals 415, for example, SnPb, may attach to the protrusions 235, thereby contaminating the contact pins 231. The contaminated material 111 may attach on the contact pins 231, which may cause contact resistance between the contact pins 231 and the external terminals 415 to increase. The contact resistance may cause unnecessary current consumption between the semiconductor package 411 and the circuit pattern of the board 211, whereby, the semiconductor package 411 may be determined as defective.

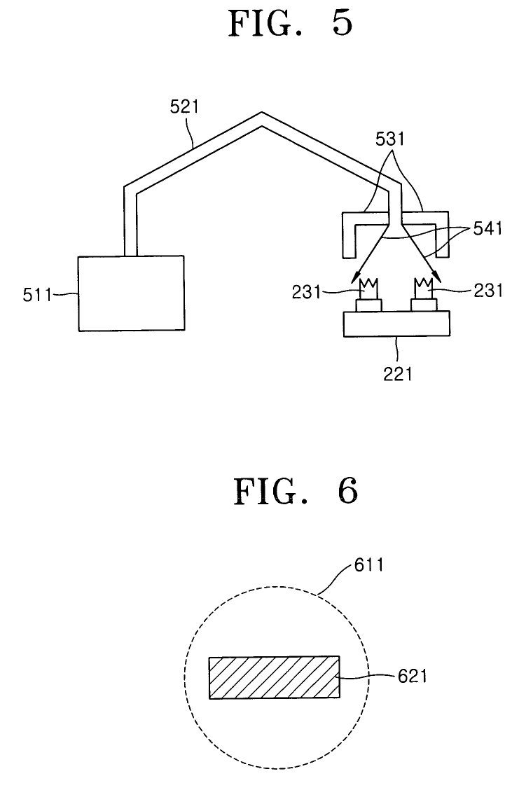

FIG. 5 illustrates an example method of irradiating laser beams onto a socket. Referring to FIG. 5, a laser oscillator 511 may generate at least one laser beam or laser light beam, and the laser beam may be transmitted through a laser transmitting pipe 521. A laser irradiating unit 531 may irradiate laser beams 541.

A to-be-cleaned socket 221 may be aligned a desired distance from the laser irradiating unit 531. For example, the socket 221 may be disposed below the laser irradiating unit 531.

When the socket 221 and the laser irradiating unit 531 are aligned, the laser beam 541 output from the laser irradiating unit 531 may be irradiated onto the contact pins 231 to be cleaned in a non-invasive (contact) manner.

FIG. 6 illustrates an example shape of a laser beam. The laser light generated from the laser oscillator 511 and transmitted through the laser transmitting pipe 521 may have a circular shape 611, but the laser beams 541 may be a rectangular shape 621 when irradiated from the laser irradiating unit 531.

Contact pins 231 may be arranged on a socket 221 in a plurality of rows, for example, two or four rows. Thus, the laser beams 541 may be formed in a rectangular shape 621 so that the laser beams 541 may be simultaneously irradiated onto at least two contact pins 231. The density and intensity of laser beams 541 inside the rectangular shape 621 are the same. In other words, because the density and intensity of the laser beams 541 may vary according to the size of the rectangular shape 621, the size of the rectangular shape 621 may be selected in the range where the density and intensity of the laser beams 541 are the same. The shape of the laser beams 541 may also be changed according to an arrangement shape of the contact pins 231.

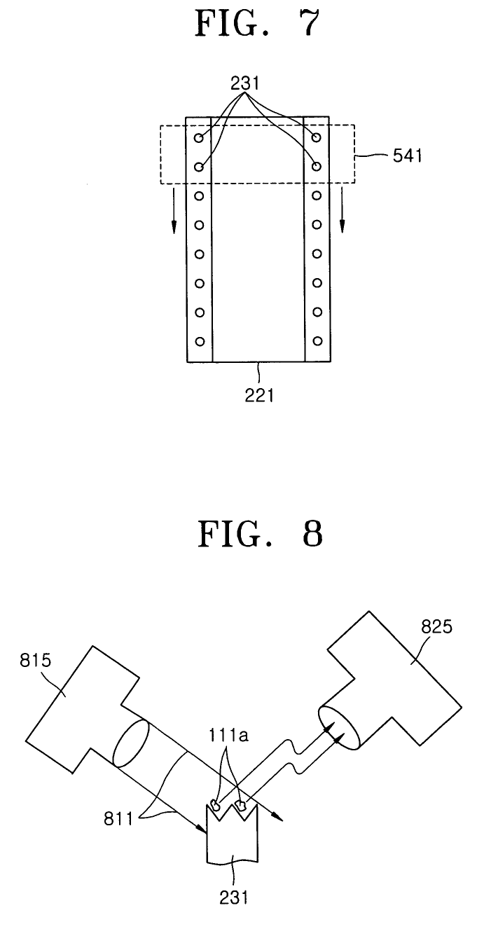

FIG. 7 illustrates the order of irradiating the laser beams 541 onto the sockets 221. Referring to FIG. 7, the laser beams 541 may be simultaneously irradiated onto the contact pins 231, whereby the efficiency at which the sockets 221 are cleaned increases.

FIG. 8 illustrates a method of blowing air onto the contact pins and/or vacuuming contaminated materials when cleaning the socket. Referring to FIG. 8, when an air blowing unit 815 blows air 811 onto the contact pins 231 from an oblique angle from an upper portion of the contact pins 231, the contaminated material 111a attached on the contact pins 231 may be removed.

If air 811 is blown from side angle of the contact pins 231, rear protrusions may be blocked by front protrusions and air 811 may not sufficiently collide with the rear protrusions so that the contaminated material 111a may not be completely removed. In addition, when air 811 is vertically blown onto the contact pins 231, the air blowing unit 815 may block a portion of the laser beam 541s and decrease cleaning of the contact pins 231.

Referring to FIG. 8, a vacuum unit 825 arranged at an oblique angle from an upper portion of the contact pins 231 may vacuum the contaminated material 111a detached from the contact pins 231. The contaminated material 111a detached from the contact pins 231 may be vacuumed away by the vacuum unit 825.

If the contaminated material 111a is vacuumed from a side angle of the contact pins 231, rear protrusions may be blocked by front protrusions so that the contaminated material 111a on the rear protrusions may not be completely removed. In addition, when the contaminated material 111a is removed from the upper portion of the contact pins 231, the vacuum unit 825 may block a portion of the laser beam 541 and disturb cleaning of the contact pins 231.

As described above, air 811 may be blown onto the contact pins 231 when the laser beams 541 are irradiated onto the contact pins 231. Accordingly, the contaminated material 111 attached on the contact pins 231 may be removed. In addition, the contaminated material 111a detached from the contact pins 231 may be vacuumed by the vacuum unit 825 so that the sockets 221 may be kept cleaned.

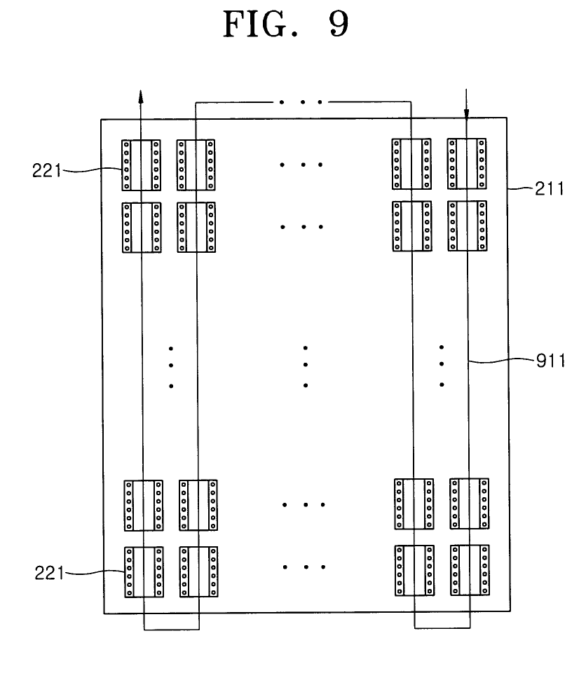

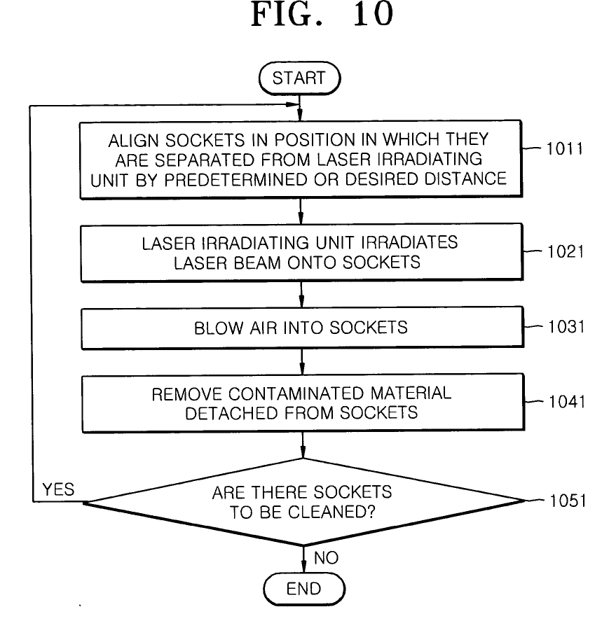

FIG. 9 illustrates an example order of cleaning the sockets. Referring to FIG. 9, to clean the sockets 221 provided on the board 211 in a plurality of rows, the sockets 221 may be cleaned starting from a first row in a zigzag pattern. Thus, a speed at which the sockets 221 are cleaned may be increased.

FIG. 10 is a flowchart illustrating a method of cleaning sockets according to an example embodiment. Referring to FIG. 10, the method for cleaning sockets may include operations 1011 to 1051. The method illustrated in FIG. 10 will now be described with reference to FIGS. 2 through 9.

In operation 1011, sockets 221 may be aligned at a desired distance from a laser irradiating unit 531. For example, the sockets 221 may be disposed below the laser irradiating unit 531. Board 211 may be fixed, and the laser irradiating unit 531 may be moved and aligned with the sockets 221, or the laser irradiating unit 531 may be fixed and the board 211 may be moved and aligned with the laser irradiating unit 531. A method of moving and aligning the laser irradiating unit 531 or the board 211 may be realized using well-known methods.

In operation 1021, the laser irradiating unit 531 may irradiate laser beams 541 onto the sockets 221. The laser beams 541 may have a desired shape, for example, a rectangular shape, so that the laser beams 541 may be simultaneously irradiated onto contact pins 231, and then may be irradiated onto the sockets 221. For example, when the sockets 221 in which the contact pins 231 are arranged in two rows are cleaned, the laser beams 541 may be shaped in a rectangular shape so that it may be simultaneously irradiated onto at least two contact pins 231. The shape of the laser beams 541 may be adopted in various ways according to an arrangement shape of the contact pins 231 provided at the sockets 221.

In operation 1031, air 811 may be blown onto the sockets 221. If the laser beams 541 are irradiated onto the contact pins 231, contaminated materials 111a may become detached from the contact pins 231. Air 811 may be blown onto the contact pins 231 so that the contaminated material 111a may become more completely detached from the contact pins 231. Air 811 may be blown onto the contact pins 231 from an oblique angle from an upper portion of the contact pins 231 so that air 811 may be more uniformly supplied to all areas of the contact pins 231 and the contaminated material 111a may be more completely removed.

In operation 1041, the contaminated material 111a detached from the contact pins 231 may be vacuumed away. The contaminated material 111a detached from the contact pins 231 may be vacuumed by a vacuum unit 825 so that the sockets 221 and/or the Board 211, for example, Hi-Fix board 211 are kept clean. If the contaminated material 111a is adhered to the sockets 221 or the Board 211, for example, Hi-Fix board 211, error readings may occur during a test operation.

In operation 1051, operations 1011 to 1041 may be repeated on another socket. In other words, if cleaning of one socket is completed, the cleaning operation may be consecutively performed on another socket so that all of the sockets provided on the board 211 may be quickly cleaned.

The laser beams 541 may be irradiated onto the contact pins 231 and air 811 blown onto the contact pins 231. In addition, the contaminated material 111a detached from the contact pins 231 may be vacuumed away so that the contaminated material 111a stuck on the contact pins 231 may be more completely removed. As a result, test yields of semiconductor packages may be improved.

As described above, in a method of cleaning a socket according to example embodiments of the present invention, laser beams 541 may be irradiated onto contact pins 231 of sockets 221. Air 811 may be blown onto the contact pins 231, and contaminated materials 111a detached from the contact pins 231 may be vacuumed away such that the sockets 221 may be more completely cleaned.

The sockets 221 may be cleaned using a mechanical method such that a manual process may not be needed. In addition, a plated material of the contact pins 231 may not peel off such that contact resistance of the contact pins 231 is affected.

Thus, test errors caused by contamination of the contact pins may be prevented from occurring such that the test yield of the semiconductor packages may be improved.

Although example embodiments described above may include irradiating a laser, blowing air, and applying a vacuum, other example embodiments may include any subset of these three operations.

While example embodiments have been particularly shown and described, it will be understood by those of ordinary skill in the art that various changes in form and details may be made therein without departing from the scope of the following claims.

What is claimed is:

1. A method of cleaning a socket including a plurality of contact pins used to test semiconductor packages comprising:
irradiating a laser beam onto the socket have to remove contaminated materials on the plurality of contact pins.

2. The method of claim 1, further comprising:
simultaneously blowing air onto the plurality of contact pins while the laser beam is irradiated onto the plurality of contact pins.

3. The method of claim 2, further comprising:
vacuuming the contaminated materials from the plurality of contact pins.

4. The method of claim 2, wherein the air is blown onto the plurality of contact pins from an oblique angle above the plurality of contact pins.

5. The method of claim 3, wherein the contaminated materials is vacuumed away from an oblique angle above the plurality of contact pins.

6. The method of claim 1, wherein a shape of the laser beam irradiated onto the socket is rectangular.

7. The method of claim 1, wherein the plurality of contact pins are arranged on the socket in a plurality of rows.

8. The method of claim 7, wherein the laser beam is irradiated in a zigzag manner on the plurality of rows.

9. The method of claim 1, wherein the laser beam is irradiated by a laser irradiating unit.

10. The method of claim 9, wherein the socket is disposed in a plane and the laser irradiating unit is disposed above the socket.

11. The method of claim 9, wherein the laser beam is shaped so that the laser beam is simultaneously irradiated onto the plurality of contact pins.

12. The method of claim 1, wherein the socket is arranged on a board and a plurality of sockets are arranged on the board.

13. The method of claim 1, wherein the contact pins are pogo pins.

14. The method of claim 13, wherein a plurality of sharp protrusions is formed on ends of the pogo pins.

15. The method of claim 1, further comprising:
vacuuming the contaminated materials from the plurality of contact pins.

16. The method of claim 15, wherein the contaminated materials is vacuumed away from an oblique angle above the plurality of contact pins.
